(19) United States
(12) Patent Application Publication
(10) Pub. No.: US 2004/0224086 A1
(43) Pub. Date: Nov. 11, 2004

(54) Automated hot melt application apparatus and method

(76) Inventor: Ryan Erin Wright, Harrisville, UT (US)

Correspondence Address: HARNESS, DICKEY & PIERCE, P.L.C., P.O. BOX 828, BLOOMFIELD HILLS, MI, 48303, US

(21) Appl. No.: 10/429,374

(22) Filed: May 5, 2003

(51) Int. Cl. B05D 5/10; B05C 11/00

(52) U.S. Cl. 427/207.1; 427/421.1; 118/667

(57) ABSTRACT

An automated hot melt adhesive application apparatus useful in the manufacture of furniture padding. The apparatus includes a glue head attached to an X-Y-Z positioner. A conveyor belt positions a padding article near the glue head and a bead of adhesive is sprayed in a preselected pattern on the article.

### FIELD OF THE INVENTION

The present invention relates generally to padded articles of furniture and more specifically to an apparatus for and method of assembling articles for use in padded furniture. Typically, padded articles of furniture that are manufactured on an assembly line are produced by a method that includes joining various pieces of foam and liners. Generally, these pieces of foam are cut to specified shapes and glued to materials such as other foam pieces, Duon™ sheets or shoddy pads prior to foam upholstering and/or installation within an article of furniture. In order to join these pieces of foam and padding together, a typical method involves spraying glue or a hot melt adhesive onto the articles prior to joining them. A hand held glue gun is used to spray along the outline of each foam pad prior to assembly. While these conventional practices operate satisfactorily for their intended purpose, furniture manufacturers are continually striving to developed improved automated systems to produce a more consistent product an efficient assembly method.

### SUMMARY OF THE INVENTION

Accordingly, the present invention is directed to an automated hot melt adhesive application apparatus and method. In one aspect of the present invention, hot melt adhesive application apparatus is provided that includes a supply of hot melt material, an application nozzle that is adapted to dispense the hot melt material at a preselected temperature and an X-Y positioner that is adapted to manipulate the nozzle about the perimeter of an article.

In another aspect, the present invention provides a method of applying an adhesive to an article that includes positioning the article adjacent an adhesive application apparatus, communicating the outline of the article to the apparatus to an X-Y positioner, and automatically applying a bead of adhesive through a nozzle manipulated by the X-Y positioner in a predetermined pattern on the article defined, in part, by the outline of the article. The adhesive application apparatus includes a computer controlled module that can store multiple patterns to control the automatic application of the adhesive. In yet another aspect of the present invention, a method of manufacturing foam padding assemblies is provided.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of the frame and a partial assembly of the automated hot melt adhesive application apparatus of the present invention;

FIG. 2 is a end view of the apparatus of FIG. 1 and further showing the glue application system taken along the X axis shown with the supply hose removed for clarity;

FIG. 3 is a side view of a portion of the apparatus of FIG. 2, taken along the Y axis;

FIG. 4 is a top view of a portion of the apparatus of FIG. 2; taken along the Z axis;

FIG. 5 is a closeup of the glue head of the apparatus of FIG. 2;

FIG. 6 is a perspective view of an article illustrating the glue pattern applied by the apparatus of the present invention; and

FIG. 7 is a perspective of an alternate article illustrating a corresponding glue pattern applied by the apparatus of the present invention.

### DETAILED DESCRIPTION OF THE PREFERRED EMBODIMENTS

The following description of the preferred embodiments is merely exemplary in nature and is in no way intended to limit the invention, its application, or uses.

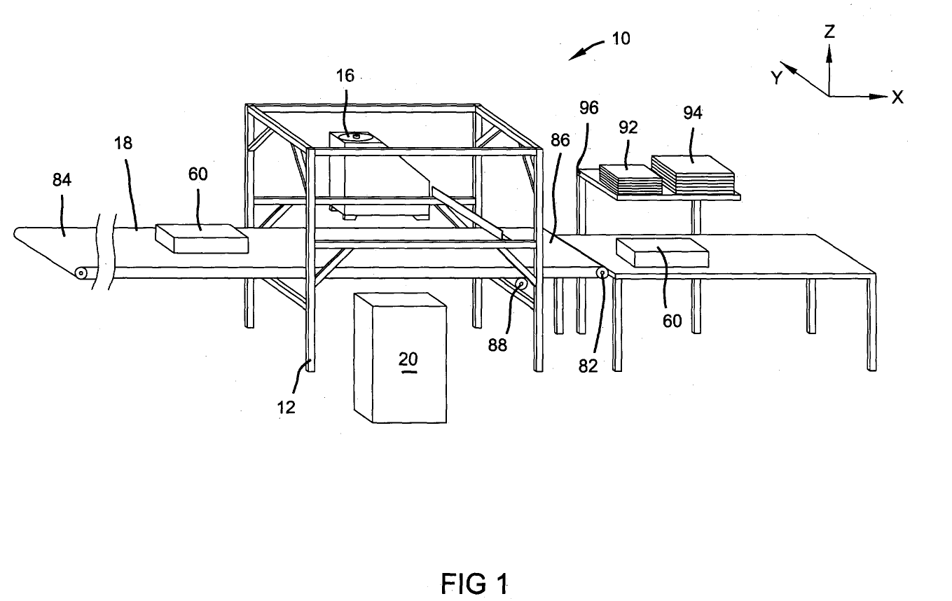

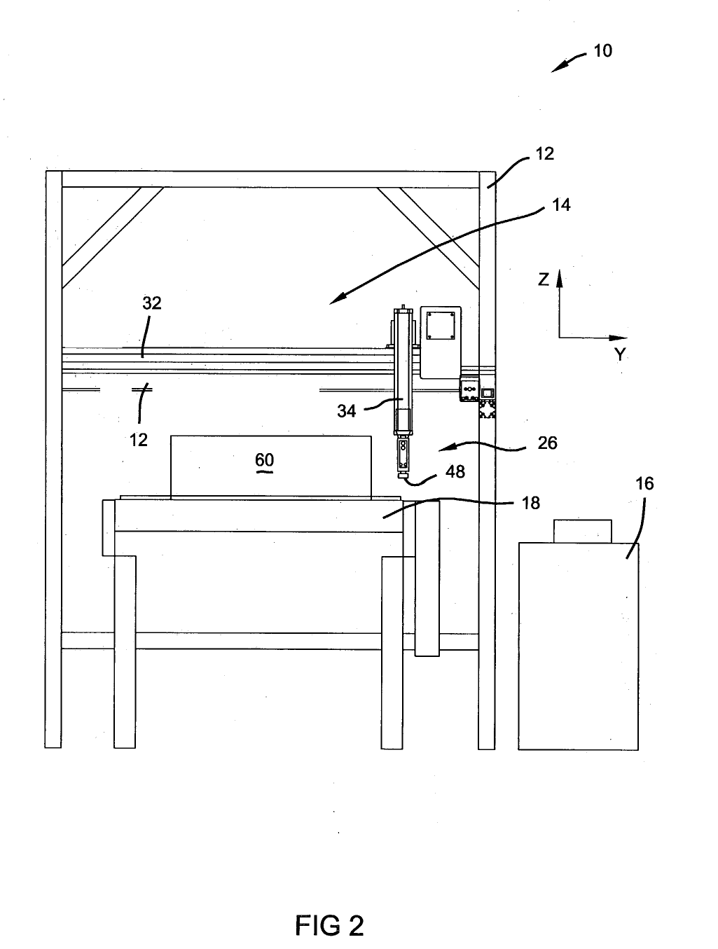

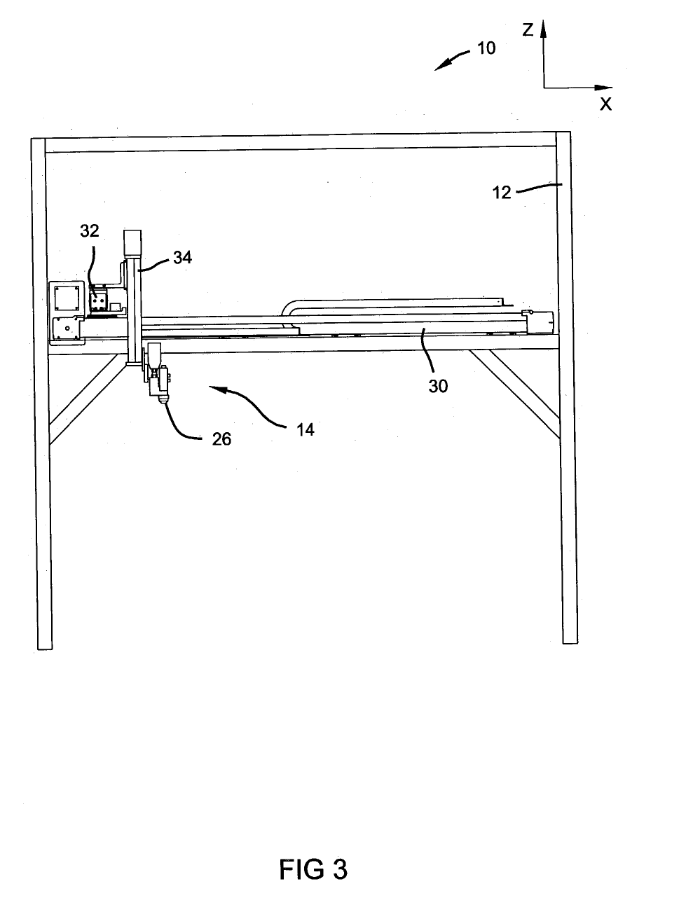

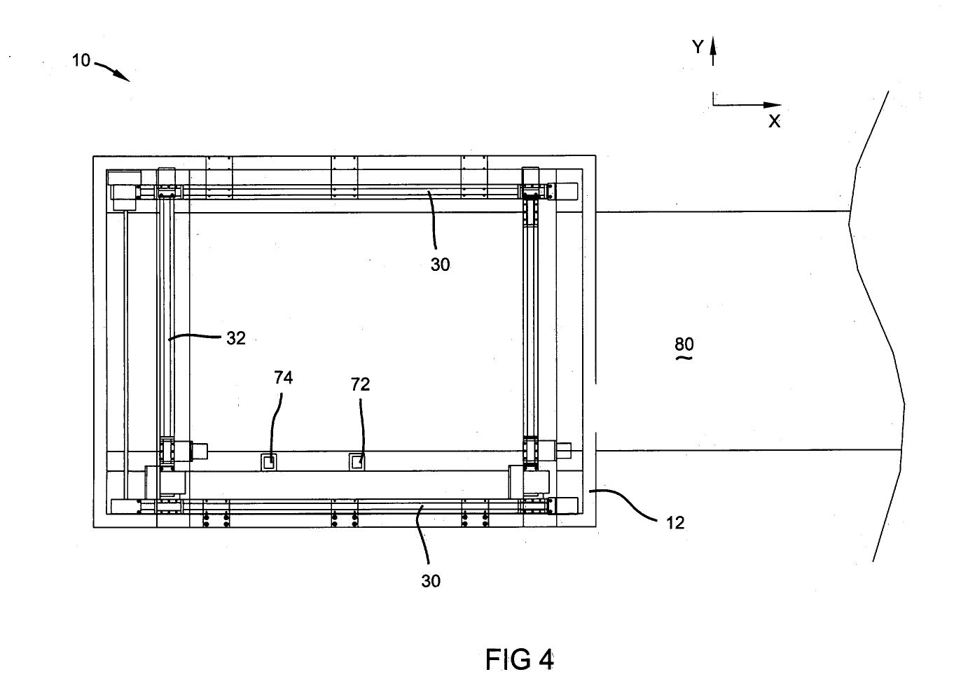

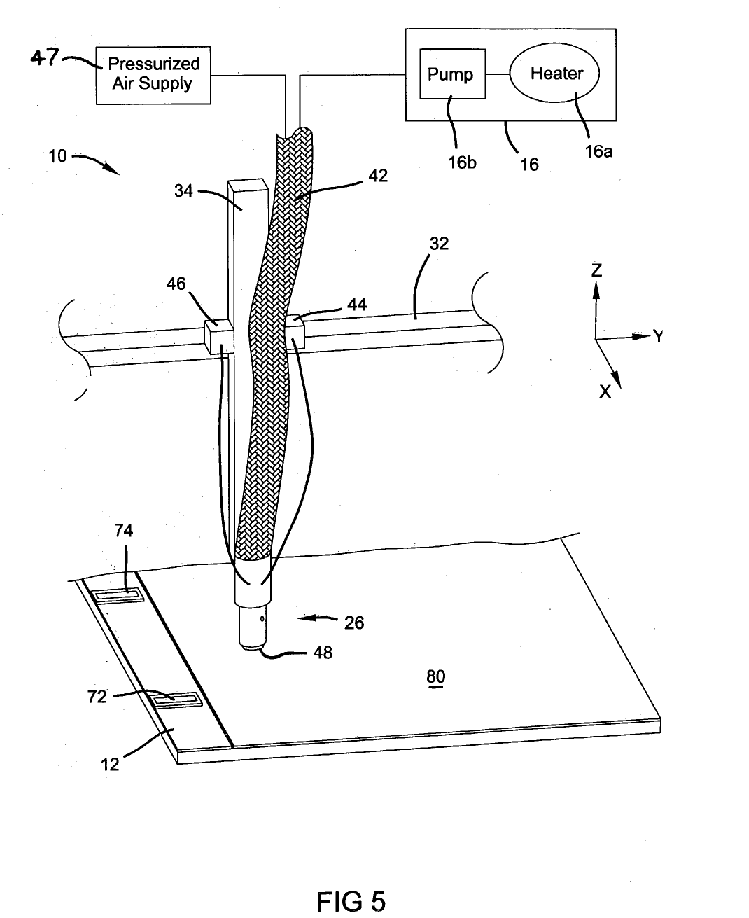

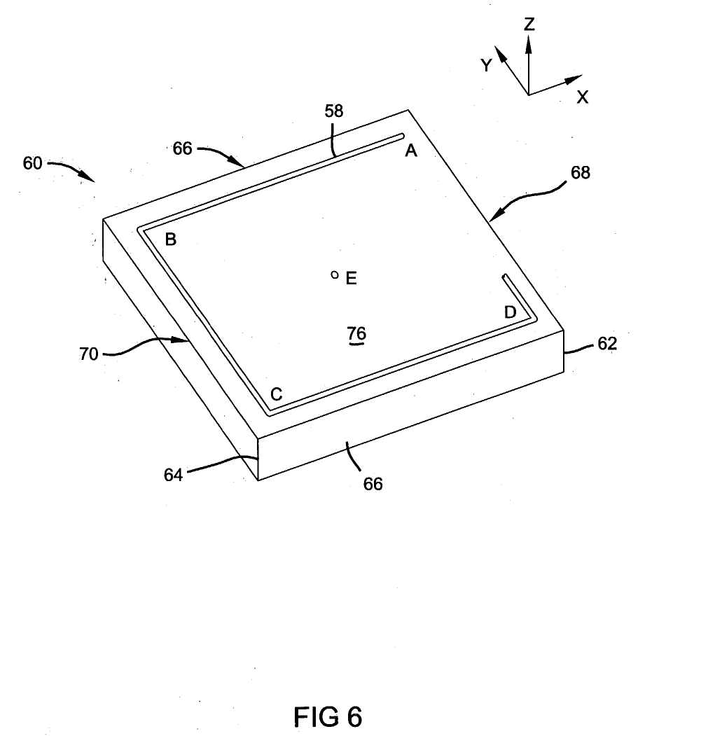

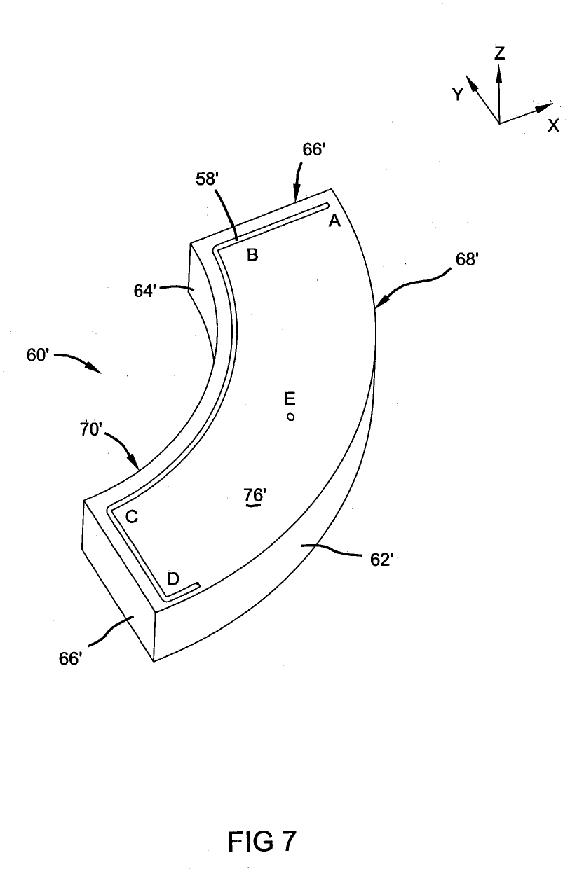

With reference to FIGS. 1-4, an exemplary automatic hot melt adhesive application apparatus is shown to include a support frame 12, a glue application system 14, a hot melt supply 16, a conveyer 18, and a control system 20. As best seen in FIG. 1, support frame 12 is constructed of structural members to straddle conveyor 18. Glue application system 14 is shown in FIGS. 2-4 to include an X axis positioner 30, a Y axis positioner 32 and a Z axis positioner 34. A glue head 26 is coupled to positioners 30, 32, and 34 such that glue head 26 can be translated with respect to frame 12 in the X, Y, and Z axis. As best seen in FIG. 5, glue application system 14 includes glue head 26, a supply hose 42, an air solenoid 44, a glue solenoid 46, and a nozzle 48. As will be described later, hot melt supply 16 supplies a hot melt adhesive 54 to glue application system 14 in order to apply a bead 58 of hot melt adhesive 54 to a first article 60, as discussed below. FIG. 6 illustrates a first article 60 that includes a leading face 62 having a leading edge 68, a trailing face 64 having a trailing edge 70 and sides 66. Similarly, FIG. 7 illustrates a second article 60′ that includes a leading face 62′ having a leading edge 68′, a trailing face 64′ being a trailing edge 70′ and sides 66′. The apparatus 10 is shown in FIG. 4 to further include a leading edge sensor 72 and a trailing edge sensor 74.

Leading edge 68 is the foremost edge of first article 60 and trailing edge 70 is the rear most edge of first article 60 as first article 60 travels on conveyor 18. As discussed below, leading edge sensor 72 detects leading edge 68 in order to stop conveyor 18 and position first article 60 for operation of glue application system 14 and trailing edge sensor 74 detects trailing edge 70 when first article 60 has reached second end 86 of conveyor 18.

Conveyor 18 is preferably a conventional conveyor belt assembly that includes a belt 80, rollers 82, a first end 84 and a second end 86. Preferably, belt 80 is a silicon belt that resists adhesion to hot melt adhesive 54. A self-cleaning roller 88 is located under rollers 82 and in contact with belt 80. Roller 88 is an idler roller that has a suitable surface treatment for removing and collecting overspray of hot melt adhesive 54 from belt 80. Hot melt supply 16 includes a heater 16a and a pump 16b. Preferably hot melt supply 16 is a Proflex G350 available from Hot Melt Technologies, Inc. of Rochester, Mich., although hot melt supply 16 could be any apparatus capable of supplying a heated adhesive. As presently preferred, glue head 26 is an automatic spray head such as Model AV 600-R equipped with a nozzle 48 such as Model 915-018 spray nozzle, and a supply hose 42 such as DG-0616S hose, all available from Hot Melt Technologies, Inc. of Rochester, Mich. As also presently preferred, glue head 26 and nozzle 48 atomize hot melt adhesive 54 and direct this atomized adhesive in a swirling jet to form bead 58.

When assembled, nozzle 48 is in fluid communication with air solenoid 44 and glue solenoid 46. Supply hose 42 is in fluid communication with glue solenoid 46 and hot melt supply 16. Air solenoid 44 is operable to supply a source of pressurized air 47 to nozzle 48.

In preparing for operation, hot melt adhesive 54 is transferred to hot melt supply 16 and the heater is activated to warm hot melt adhesive 54 to a desired, preselected temperatured. A supply of first article 60, is positioned near first end 84 of conveyor 18 with one first article 60 positioned on belt 80 in a predetermined orientation. The identification data for first article 60 is entered into the control system 20. As presently preferred, control system 20 uses the identification data to recall various processing parameters such as size, shape, thickness and spray pattern for a given cushion which one entered in a memory. Control system 20 is capable of detecting an input representative of a specified first article size and directing the X, Y, and Z positioners 30, 32, and 34 in coordination with glue head 26 to form a bead 58 in the preselected pattern. As presently preferred, the input to control system 20 to identify the specific article 60 adjacent nozzle 40 may be input by any suitable data entry means. The pump is activated and supply hose 42 and glue head 26 are heated to desired preselected temperatures. Conveyor 18 is activated and transports the first article 60 to a position adjacent nozzle 48 wherein sensor 72 detects the presence of first article 60. Sensor 72 sends a signal to control system 20 to stop conveyor 18. Z positioner 34 adjusts nozzle 48 to a predetermined height H (not shown) above first article 60. Height H and the pressure of air allowed into nozzle 48 are selected such that the glue jet from nozzle 48 will produce a desired bead 58 width. With first article 60 and nozzle 48 thus positioned, the X and Y positioners 30, 32 translate nozzle 48 as hot melt adhesive 54 is applied to article 60 in a preselected pattern.

As illustrated in FIG. 6, glue application system 14 directs a jet of hot melt adhesive 54 beginning at location A as X positioner 30 translates nozzle 48 from location A to location B thereby depositing a bead 58 of hot melt adhesive 54. Bead 58 is continued in a pattern on first article 60. As presently preferred, bead 58 is applied approximately one inch from the upper edges of first article 60. As best illustrated in FIG. 6, bead 58 is preferably deposited in a pattern as the jet of hot melt adhesive traverses a path between locations A, B, C, D, and E. Locations A, B, C, and D are approximately one inch from the edges of top surface 76, located adjacent the corners of first article 60. Location E is approximately in the center of first article 60. Also presently preferred, Z positioner 34 maintains nozzle 40 at a height H of approximately two inches above the top surface 76 of first article 60 and X and Y positioners 30, 32 maintain the speed of nozzle 48 relative to article 60 at approximately 13 inches per second to achieve a preferred bead 58 deposition amount.

After application of bead 58 in the desired pattern, control system 20 starts conveyor 18 to transfer first article 60 for further assembly, as discussed below. As first article 60 is transferred away from glue application system 14, trailing edge sensor 74 detects when trailing edge 70 has reached second end 86 of conveyor 18. When trailing edge sensor 74 detects trailing edge 70, a signal is sent to control system 20 to stop conveyor 18.

FIG. 7 illustrates a bead 58 deposited on a first article 60′ wherein first article 60′ has an outline that differs from the outline of first article 60. As will be appreciated, different desired patterns for bead 58 can be programmed into control system 20 to produce multiple patterns on first articles 60 or to accommodate multiple articles with different outlines.

An acceptable bead 58 is formed when specific parameters of apparatus 10 are controlled for the given application with materials. As presently preferred, adhesives 34-6650 and 34-713A, available from National Starch and Chemical Company of Bridgewater, N.J., are used as the hot melt adhesive 54 with hot melt supply 16 maintained in a range of 300° F.-350° F. and more preferably at approximately 333° F., supply hose 42 maintained in a range of 300° F.-350° F. and more preferably at approximately 320° F., and glue head 26 maintained in a range of 300° F.-350° F. and more preferably at approximately 332° F. Air solenoid 44 is connected to a supply of pressurized air 47 that is maintained at approximately 50 psi. Also presently preferred, control system 20 is programmed to activate the glue pump, wait about 300 milliseconds (ms), open air solenoid 44 to supply pressurized air to nozzle 48, wait about 200 ms, open glue solenoid 46 to initiate the jet of hot melt adhesive 54, wait about 100 ms, and then translate nozzle 48 with X, Y, and Z positioners 30, 32 and 34. This sequence has been found to produce an even deposition of bead 58 on a first article 60 in the desired pattern. It should be appreciated that an acceptable bead 58 is a function of the temperatures of nozzle 48, glue head 26, supply hose 42 and hot melt supply 16; and also a function of height H; air pressure at air solenoid 44; dimensions and design of nozzle 48; speed of nozzle 48 relative to first article 60; and physical parameters of hot melt adhesive 54. In the preferred example provided, a bead 58 of about 1.5 inches in width is deposited on the first article 60 in the desired pattern. While specific, preferred parameters and components have been identified, it should also be appreciated that a variation in some parameters or components may not significantly alter the resulting bead 58, or that changes may necessitate adjustments or changes to other parameters or components of apparatus 10. In this manner, bead 58 sets in approximately 30-45 seconds to provide adequate time for subsequent manufacturing operations.

For example, depending upon the specific padding configuration desired, second article 92 and third article 94 (as shown in FIG. 1) may be an appropriately sized piece of foam, shoddy pad, polypropylene fabric, or other material compatible with hot melt adhesive 54 and desired for use in an intermediate article of manufacture for furniture. As presently preferred, the polypropylene fabric is Duon™, available from British Petroleum, of Austell, Ga. Specifically, a first article 60, with a desired pattern of bead 58, is transferred from conveyor 18 to assembly table 96. Second article 92 is a rectangular piece of shoddy pad that is less than about one inch in thickness with a length and width that allow second article 92 to be centered on first article 90 with the corners of second article 92 positioned within the rectangle defined by locations A-B-C-D of bead 58. In this manner, second article 92 is directly secured to first article 60 with at least a portion of bead 58 that extends from location A to location E. Third article 94 is a rectangle of Duon™ having a length and width that approximates, or is slightly larger than, the length and width of first article 60. The third article 94 is placed over first and second articles 60, 92 in contact with bead 58. The assembly technician then gently presses down on the outline of third article 94 to ensure full contact between third article 94 and bead 58. This intermediate article of manufacture is then transferred to a staging area for final furniture assembly.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A hot melt application apparatus comprising:
a nozzle adapted to dispense an adhesive at a preselected temperature;
a nozzle control adapted to switch between an open position and a closed position, wherein the adhesive is sprayed through the nozzle when the nozzle control is in the open position;
a X positioner adapted to translate the nozzle in the X direction; and
a Y positioner adapted to translate the nozzle in the Y direction.

2. The apparatus of claim 1, further comprising a Z positioner adapted to translate the nozzle in the Z direction.

3. The apparatus of claim 1, wherein the X positioner and Y positioner are adapted to control the translation of the nozzle at a predetermined speed.

4. The apparatus of claim 3, wherein the predetermined speed is about 13 inches per second.

5. The apparatus of claim 2, wherein the Z positioner is adapted to maintain the nozzle at a predetermined height above a first article.

6. The apparatus of claim 5, wherein the predetermined height is about 2 inches.

7. The apparatus of claim 1, further comprising a conveyor adapted to position a first article adjacent the application nozzle.

8. The apparatus of claim 7, wherein the conveyor includes a silicone belt.

9. The apparatus of claim 7, further comprising a leading sensor to detect the leading edge of a first article, wherein the leading sensor is adapted to stop the conveyor.

10. The apparatus of claim 7, further comprising a cleaner roller in contact with the conveyor, wherein the cleaner roller is adapted to remove a hot melt overspray from the conveyor.

11. The apparatus of claim 1, further comprising a hot melt supply, wherein the hot melt supply is heated to a preselected temperature.

12. The apparatus of claim 11, wherein the preselected temperature is about 300° F.-350° F.

13 The apparatus of claim 11, wherein the preselected temperature is about 333° F.

14. The apparatus of claim 11, further comprising a supply hose operably coupled between the application nozzle and the hot melt supply wherein the supply hose is heated to a second preselected temperature.

15. The apparatus of claim 14, wherein the second preselected temperature is about 300° F.-350° F.

16. The apparatus of claim 14, wherein the second preselected temperature is about 320° F.

17. The apparatus of claim 14, wherein the nozzle is heated to a third preselected temperature.

18. The apparatus of claim 17, wherein the third preselected temperature is about 300° F.-350° F.

19. The apparatus of claim 17, wherein the third preselected temperature is about 332° F.

20. The apparatus of claim 17, wherein the preselected temperature of the nozzle is greater then the preselected temperature of the supply hose.

21. The apparatus of claim 1, further comprising a control system wherein the control system is adapted to generate a first control signal for translation of the X positioner and Y positioner, and further adapted to generate a second control signal for controlling the operation of the nozzle.

22. The apparatus of claim 21, wherein the control system is further adapted to generate a third control signal for controlling the operation of a conveyor system.

23. A method of applying an adhesive to an article comprising:
positioning the article adjacent an adhesive spray application apparatus, the apparatus including a control system;
communicating an identity of the article to the control system;
selecting a predetermined pattern based on said identity of the article; and
automatically spraying a bead of adhesive through a nozzle in said predetermined pattern to the article.

24. The method of claim 23, further comprising spraying a hot melt adhesive to form the bead of adhesive.

25. The method of claim 23, further comprising heating said nozzle prior to spraying the bead of adhesive.

26. The method of claim 23, further comprising programming the predetermined pattern into a memory, and selecting the predetermined program from the memory.

27. The method of claim 23, comprising spraying the bead of adhesive at a predetermined speed.

28. The method of claim 27, wherein the predetermined speed is about 13 inches per second.

29. The method of claim 23 wherein automatically applying a bead of adhesive includes:
starting a pump, wherein the pump is adapted to transfer the adhesive to the apparatus;
waiting a first predetermined interval of time;
opening an air solenoid, wherein the air solenoid is adapted to permit a flow of pressurized air within the apparatus to a nozzle;
waiting a second predetermined interval of time; and
opening a glue solenoid, wherein the glue solenoid is adapted to permit a flow of adhesive within the apparatus to the nozzle.

30. The method of claim 29, wherein the first predetermined interval of time is about a minimum of 300 ms.

31. The method of claim 29, wherein the second predetermined interval of time is about a minimum of 200 ms.

32. The method of claim 29, further comprising:
waiting a third predetermined interval of time; and
translating the nozzle relative the article to form the bead of adhesive on the article.

33. The method of claim 29, wherein the third predetermined interval of time is about a minimum of 100 ms.
